(19) United States
(12) Patent Application Publication
(10) Pub. No.: US 2015/0229534 A1
(43) Pub. Date: Aug. 13, 2015

(54) INTEGRATED CONTROL SYSTEM FOR DEVICES IN A PREMISE

(71) Applicant: KEY DIGITAL SYSTEMS, INC., Mount Vernon, NY (US)

(72) Inventors: Mikhail TSINBERG, New York, NY (US); Igor Yasev, Stamford, CT (US); Il Soo Yu, Fort Lee, NJ (US)

(21) Appl. No.: 14/621,130

(22) Filed: Feb. 12, 2015

Related U.S. Application Data
(60) Provisional application No. 61/939,062, filed on Feb. 12, 2014.

(51) Int. Cl. H04L 12/24; G06F 3/0482

(52) U.S. Cl. CPC H04L 41/22; G06F 3/0482

(57) ABSTRACT

A system and method is disclosed herein for controlling a plurality of electronic devices in a media system of a premise. The method includes programming an electronic configuration relating to a physical design of the control system by identifying each of the electronic devices in the premise, identifying one computing device to operate as a controller for the control system, and identifying a hardware controller that is communicates with controller and includes output ports that are physically connected to input/output ports of the electronic devices. The method further includes generating command routes to direct the operational commands from the controller to electronic devices via the hardware controller and testing the control flow of the operational commands to ensure the physical connections between the hardware controller and the electronic devices are correctly set up.

### CROSS-REFERENCE TO RELATED APPLICATIONS

This application claims priority to U.S. Patent Provisional Application Ser. No. 61/939,062, filed Feb. 12, 2014, the contents of which are incorporated herein by reference into the present application.

### FIELD

The present patent document relates generally to an integrated control system for electronic devices in a premise. More particularly, the present patent document relates to a method and system for generating a fully customizable control system with defined command routes for controlling the operation of electronic devices in a premise.

### BACKGROUND

Remote control devices are often used to manage multimedia content (e.g., digital television content) received by a set-top box by selecting the channel that is viewed, scheduling recordings, adjusting the volume, navigating electronic programming guides, and the like. Some remote control devices use infrared (“IR”) transmitters to send invisible light signals that are received directly by the set-top box. To function properly, such systems may require that the remote control is relatively close to the set-top box.

Moreover, with the increasing number of home appliances available on the market, customers are constantly dealing with more remote control devices and other means for managing the operations of each of these devices. In addition to set-top boxes, common home electronic devices include televisions, Blu-Ray players, DVD players, stereo/audio systems, security systems, light systems, and the like. Each of these electronic devices can have associated remote controllers that emit IR commands for the user to remotely control the operations thereof. Managing each of these remote controllers has become quite a burden for the home owner, who may have four or even more electronic devices in just a single room of the premise.

Currently, there are some universal and/or smart remote controllers that are designed to control multiple electronic devices. However, for these devices, the interface with the user is often complicated and varies greatly from the interface of the actual remote controller associated with the electronic device. For example, a product-specific or “out-of-the-box” remote controller may have one physical interface that is entirely different from the universal remote and/or the graphical user interface provided by a smart remote controller. These conventional designs are anything but user-friendly and are often more of a burden than a convenience, which causes the user to ultimately resort to using the “out of the box” remote controller.

Accordingly, what is needed a remote control system for wirelessly controlling all electronic appliances in a home that provide a user-friendly interface for easily managing the commands for and operations of the electronic appliances.

### SUMMARY

The present patent document relates generally to an integrated control system for electronic devices in a premise. More particularly, the present patent document relates to a method and system for generating a fully customizable control system with defined command routes for controlling the operation of electronic devices in a premise.

In particular, a system and method is disclosed herein for controlling a plurality of electronic devices in a media system of a premise. The method includes programming a visual presentation of the physical configuration of the control system by identifying each of the electronic devices in the premise, identifying one wireless or wired computing device to operate as a controller for the control system, and identifying a hardware controller that is communicates with controller and includes output ports that are physically connected to input/output ports of the electronic devices. The method further includes generating command routes to direct the operational commands from the controller to electronic devices via the hardware controller and testing the control flow of the operational commands to ensure the physical connections between the hardware controller and the electronic devices are correctly set up.

The method described herein further includes generating a software application that, when executed by a processor of the at least one computing device, causes the at least one computing device to display a plurality of graphical user interfaces. In one embodiment, generating the software application includes designating a plurality of zones in the premise and associating a portion of the plurality of electronic devices to each zone of the plurality of zones in the premise. Furthermore, the method includes receiving at least one of the operational commands via one of the graphical user interfaces. Yet further, the method includes transmitting the at least one operational command from the at least one computing device to one of the plurality of electronic devices according to a respective command route of the at least one operational command.

The method described herein further includes generating the plurality of command routes by defining a route tree defining the command routes for the operational commands.

The above and other preferred features described herein, including various novel details of implementation and combination of elements, will now be more particularly described with reference to the accompanying drawings and pointed out in the claims. It will be understood that the particular methods and apparatuses are shown by way of illustration only and not as limitations of the claims. As will be understood by those skilled in the art, the principles and features of the teachings herein may be employed in various and numerous embodiments without departing from the scope of the claims.

### BRIEF DESCRIPTION OF THE DRAWINGS

The accompanying drawings, which are included as part of the present specification, illustrate the presently preferred embodiments and together with the general description given above and the detailed description of the preferred embodiments given below serve to explain and teach the principles described herein.

FIG. 1 illustrates an exemplary embodiment of the integrated control system according to the invention.

FIG. 2A illustrates a block of a master controller according to an exemplary embodiment.

FIG. 2B illustrates a screenshot of the learning (scanning) of IR control signals of an electronic device according to an exemplary embodiment.

FIG. 3 illustrates a block diagram including a PC editor for programming the controllers according to an exemplary embodiment.

FIG. 4 illustrates an exemplary screenshot of the PC editor according to an exemplary embodiment.

FIG. 5A illustrates a command route tree provided in the system designer widow of the PC editor according to an exemplary embodiment.

FIG. 5B illustrates a command route tree for control zones that is provided in the system designer widow of the PC editor according to an exemplary embodiment.

FIGS. 6A and 6B illustrates examples of the visual module editor according to an exemplary embodiment of the present invention.

FIGS. 6C and 6D illustrate additional screenshots of the PC editor for generating customized GUIs for the controller App(s).

FIGS. 7A-7C illustrate exemplary screenshots of the PC editor enabling the user/installer to define the variable parameters for the HDMI switcher according to an exemplary embodiment.

FIG. 8 illustrates a flowchart for uploading the control projects to the cloud according to an exemplary embodiment.

FIG. 9 illustrates a block diagram with flow signals for sequence control according to an exemplary embodiment.

FIG. 10A illustrates a coupling mechanism for connecting a user controller to the master controller according to an exemplary embodiment, and FIG. 10B illustrates a block diagram of the coupling mechanism shown in FIG. 10A.

The figures are not necessarily drawn to scale and the elements of similar structures or functions are generally represented by like reference numerals for illustrative purposes throughout the figures. The figures are only intended to facilitate the description of the various embodiments described herein; the figures do not describe every aspect of the teachings disclosed herein and do not limit the scope of the claims.

### DETAILED DESCRIPTION

Each of the features and teachings disclosed herein can be utilized separately or in conjunction with other features and teachings. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense, and are instead taught merely to describe particularly representative examples of the present teachings.

In the following description, for purposes of explanation only, specific nomenclature is set forth to provide a thorough understanding of the present invention. However, it will be apparent to one skilled in the art that these specific details are not required to practice the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present patent document also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the invention as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

FIG. 1 illustrates an exemplary embodiment of the integrated control system according to the invention. The system 100 is a fully integrated control system for electronic devices in a premise (e.g., a home, an office building or the like). The primary control component shown in the system 100 is a master controller 110. In the exemplary embodiment, the master controller 110 is connected to a wireless (or wired) network in the premise, which can be any type of local or wide area network, WiFi network or other wireless or wired data communication network as would be understood to one skilled in the art. As further shown, the system 100 includes two user controllers 120A and 120B that are programmed to function as remote controllers communicatively coupled to the master controller 110 over the wireless (or wired) network. As will be explained below, in one refinement of the exemplary embodiment the controllers 120A and 120B are connected to the master controller 110 by a wired connection. It should be appreciated that one user controller or three or more user controllers can be included in the system integrated control 100 according to alternative embodiments.

According to the exemplary embodiment, the master controller 110 serves as the control hub for the integrated control system 100. The master controller 110 is coupled to a plurality of electronic devices 130, i.e., non-controlling devices, in the premise (e.g., televisions, thermostats, lighting units, security systems, audio systems, and the like) by data communication means such as infrared (IR) data communication, RS-232 connections, Internet Protocol (IP) commands, and the like.

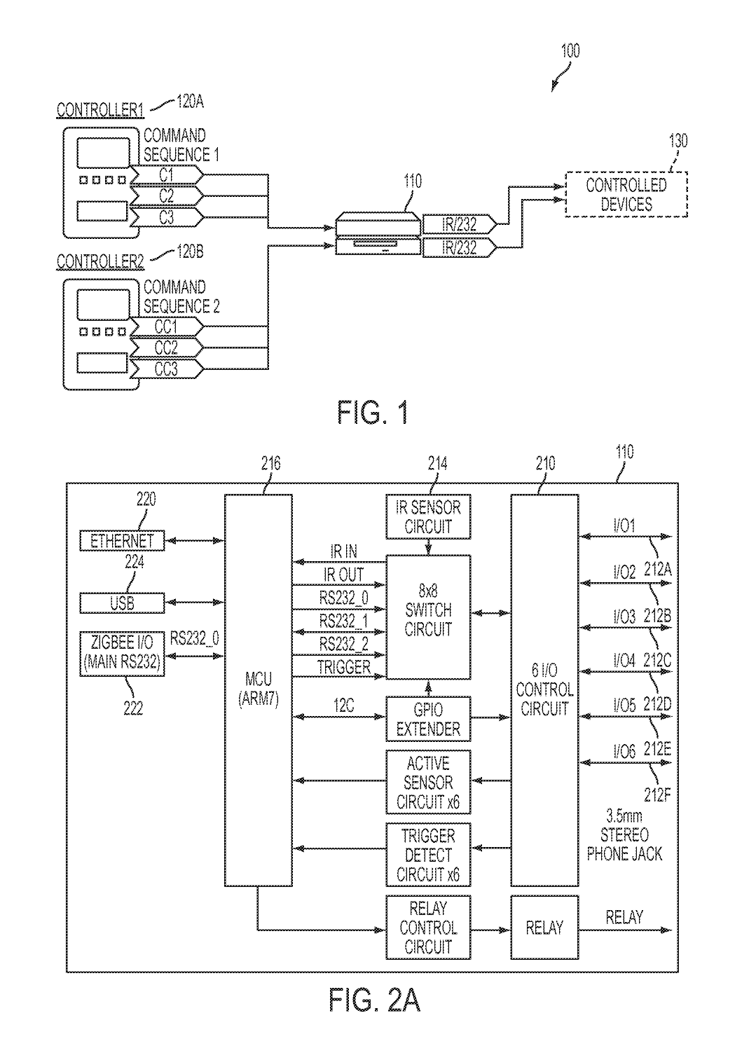

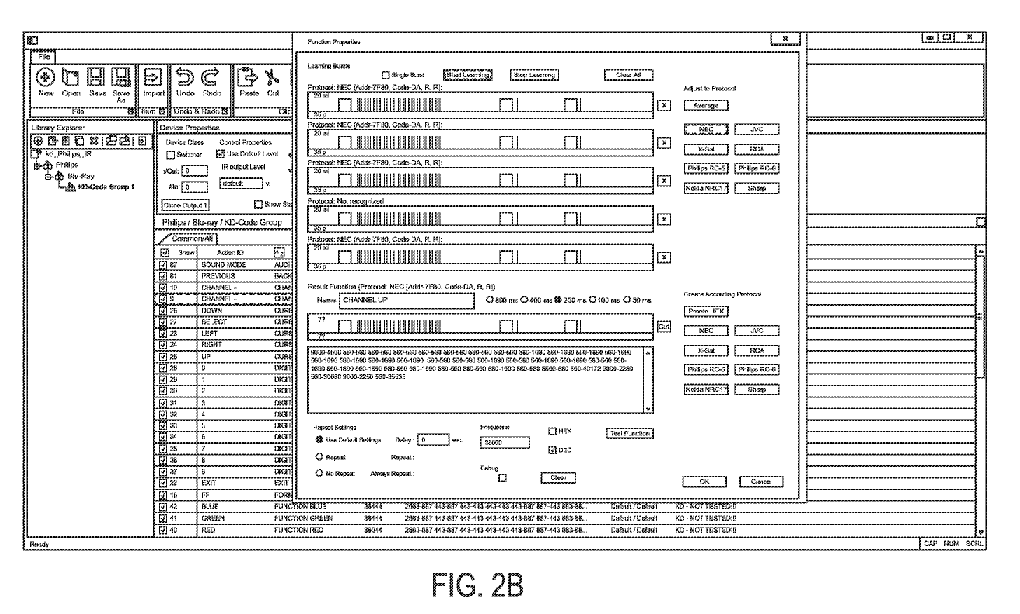

FIG. 2A illustrates a block of the master controller 110 according to an exemplary embodiment. As noted above, the master controller 110 serves as the control hub for the integrated control system 100. As shown, the master controller 110 includes an input/output (“I/O”) control circuit 210 and a plurality of I/O ports 212A-212F that allow IR, RS-232 and sensor control of the system and the peripheral audio/video (“A/V”) components.

In addition, the master controller 110 includes an IR sensor circuit 214 that enables IR learning. FIG. 2B illustrates a screenshot of the learning (scanning) of IR control signals of an electronic device according to an exemplary embodiment. In this example, a remote control, for example, for a television that is to be controlled by the integrated control system 100, provides a series of learning bursts (i.e., IR signals) to the IR sensor circuit 214. In the exemplary embodiment, the integrated control system 100 includes a database of IR command controls for all possible electronic devices. Based on the learning bursts generated when the user presses certain buttons on the remote control, the integrated control system 100, and preferably the master controller 110, identifies the standard for the specific remote control device based on the specific data transmission of the learning bursts. Based on the standard, the system can identify delay and timing errors that are inherent to any IR based remote control device and generate a new error-free code for command signals that are ultimately generated by the integrated control system 100. These signals can be saved to the IR database manager.

Referring back to FIG. 2A, the master controller 110 further includes a microcontroller unit (“MCU”) chipset 216 used as the main controller that controls all devices via the internal and external interfaces. In addition, the master controller 110 includes an Ethernet port 220, which can be a single Ethernet LAN port or the like, a main RS232 port 222, which can be a RS232 serial port or the like, and a USB (Universal Serial Bus) port 224 that can be used for upgrading application firmware or debugging. It is noted that there are additional exemplary electronic components shown in FIG. 2A for the master controller 110. These components would be readily understood to one skilled in the art and are not described herein so as to not unnecessarily obscure the aspects of the invention.

Although not shown, it is contemplated that the master controller 110 includes a front panel with a plurality of light emitting diode (“LED”) indicators to illustrate the status of the unit. For example, these LED indicators can include: a power indicator, a link indicator, a status indicator, a sensor indicator, and indicators for the IR/RS-232 ports and for the relays. Moreover, it is contemplated that the back panel of the master controller 110 has a pair of Phoenix connectors for using the relays (each has Common, NO and NC contacts) and a plurality of IR/RS-232 3.5 mm stereo phone jacks 212. These ports can also be programmed to operate as sensors to determine the state of a piece of equipment. In the exemplary embodiment, the master controller 110 includes a reset button, a ⅛″ main Serial port for the main RS-232 connection with four conductors audio jack 222, a RJ-45 Network connector 220, a USB connector 224 and the power connector.

Referring back to FIG. 1, the user controllers 120A and 120B can be a third-party user/personal computing device with wireless data communication abilities, such as an Apple iPad®, iPod Touch® or iPhone®, a Samsung Galaxy Tab® or any other smartphone, tablet or the like. In the exemplary embodiment, the controllers 120A and/or 120B download a software control application (i.e., an “App”) to manage the control of the integrated control system 100. More specifically, the App provides graphical user interfaces that enable the user to operate all of the electronic devices 130 in the premise that are communicatively coupled to the master controller 110 as part of the integrated control system 100. Preferably, the App includes viewing scaling features that facilitate the user's use of the controller, such that all the control elements of the App in the exemplary embodiment remain in the window when the user resizes the browser window. Thus, when the user zooms in, the aspect ratios of elements may change, but the control elements remain in the window, enabling the user to continually operate the control elements of the App.

As shown in FIG. 1 and as will be discussed in more detail below, it is also contemplated that multiple devices controllers (e.g., controllers 120A & 120B) can be registered as controllers for the integrated control system 100, although it should be understood that a single controller can be used for the integrated control system 100. In the exemplary embodiment, one of the controllers (e.g., controller 120A) can be assigned as a master user controller and one or more secondary user controllers can be assigned as a secondary or slave controller (e.g., controller 120B). In another embodiment, the different controllers 120A and 120B can be assigned to different “zones” of the premise that are under the control of the integrated control system 100 in the premise. As will be discussed in greater detail below, zones are different spatial locations, such as different rooms, of the premise.

The App may further include a power saving mode for the specific controller (e.g., an Apple iPad®) that is separate from the general hibernation mode provided by the Apple iOS operating software. For example, after a period of time (e.g., 1 minute) or in response to a user input, the controller 120A or 120B can enter an idle state as a power saving mode to minimize power consumption by the device. In another refinement of the exemplary embodiment, the App on the controller can provide a ticker line (or similar overlay) over a portion of the customer interface that provides text information about one or more devices under the control of the integrated control system 100. For example, if the customer is operating one or more devices in a particular zone (e.g., the family room), the ticker line may provide an operation status of each device/controller in that zone.

Although not shown in FIG. 1, it is further contemplated that a matrix switcher is provided in one embodiment that allows for AN switching and expands the control capabilities of the overall integrated control system 100. In general, the matrix switcher is a separate electronic component configured to route the control signals (e.g., IR, RS-232 and the like), to the remote sources or displays. In one refinement of the embodiment, the matrix switcher includes databases that are structured based on the outputs. In particular, the control software creates individual tabs (sections) of commands for each output of a device that contains multiple outputs (AV receiver, switcher, matrix, and the like). This configuration allows for simple and intuitive programming and understanding of commands since they are categorized by output. The matrix switcher provides for greater inputs and outputs for hardware devices to interconnect with display devices, and, therefore, can be used in the exemplary embodiment, for example, when there is more than one display in a system and those displays access at least one source device.

Details of a format switcher according to one embodiment are described in U.S. patent application Ser. No. 13/630,798, filed Sep. 28, 2012, the entirety of the contents of which are hereby incorporated by reference. This component will hereafter be referred to as the “matrix switcher” or the “KD-4×4-Switcher”.

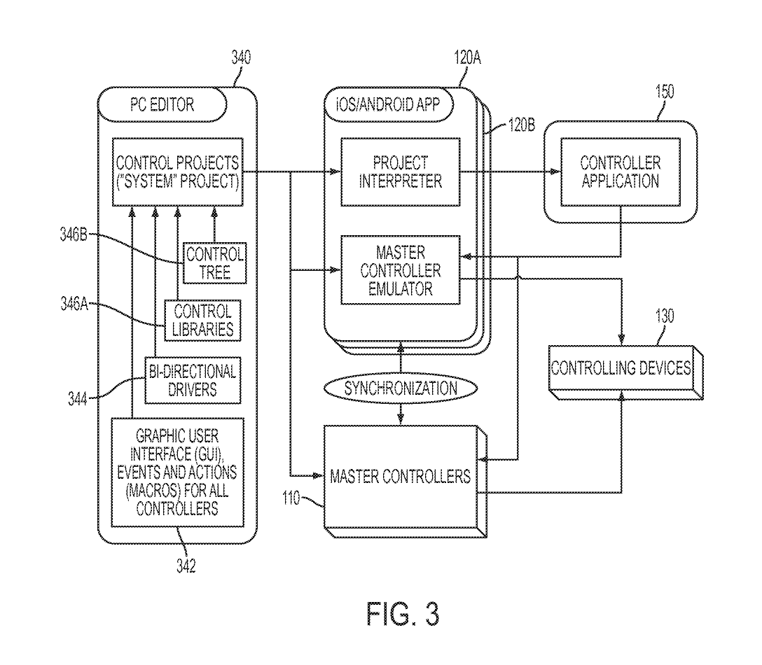

FIG. 3 illustrates a block diagram including a PC editor for designing the integrated control system and generating the App(s) for the controllers according to an exemplary embodiment. In particular, the App that is downloaded to the user controllers 120A and/or 120B for controlling the electronic devices 130 in the integrated control system 100 is created by a user and/or installer and/or system designer (these terms are used interchangeably herein) using a personal computer (“PC”) editor 340 according to an exemplary embodiment. As shown in FIG. 3, the PC editor 340 is a software application that can be installed and/or executed on a conventional PC and provides a user with a step-by-step procedure to perform the basic programming process for the App plus tools to create unique/customizable control interfaces for the controllers 120A and 120B. Once all of the audio/video electronic devices 130 are physically installed in the premise and connected to the master controller 110, the system 100 is set up using the PC editor 340. The PC editor 340 is a software application that enables the user/installer to program a project relating to the physical configuration of the control system, including the user and master controller(s) and non-controlling devices, to designate the command routes for the control, and to generate graphical user interfaces (“GUIs”) that can be downloaded to the user controllers as part of the “App” and used to wirelessly operate the electronic devices 130 in the premise.

As shown in FIG. 3, the PC editor 340 includes one or more electronic databases providing templates for a plurality of GUIs 342 for all controllers, a plurality of bi-directional drivers 344, a control library 346A and a control tree 246B. Each of these databases can be accessed during programming of the “control project” 348 or App for the controllers 120A and 120B to generate the unique and customized user interfaces for the user.

Initially, the integrated control system 100 must be configured by selecting each electronic device 130 that will be controlled by the system. This configuration can be performed by the user by identifying device data in the database for each of the plurality of electronic devices by entering identification data relating to the plurality of electronic devices. In particular, using the PC editor 340, the devices are designated by first selecting a control platform (e.g., “IR”) and then entering a brand (e.g., “Samsung®”) from a “system configuration” tab of the PC editor 340. In particular, the control library 346 contains numerous electronic device configurations (i.e., identification data and the like) that correspond to a plurality or all possible electronic devices that may be found in a user's premise. For example, the control library will contain data relating to each possible television, game system, lighting system, security system, any other audio/video devices, etc., that is commercially or otherwise available to the user. It is contemplated that the device configuration data stored in the control library 346 is updated by a system administrator on the backend of the server for the PC editor 340.

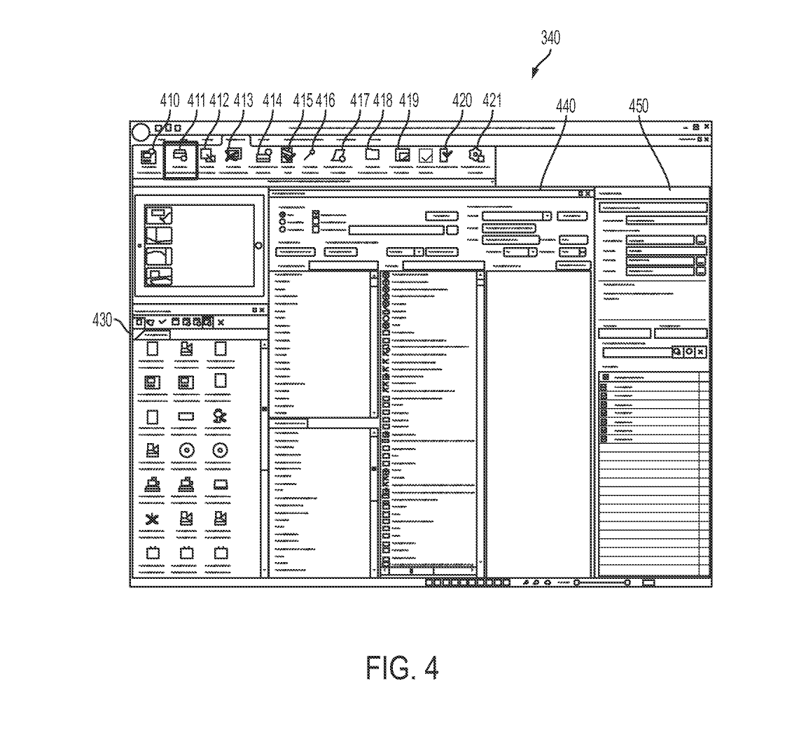

FIG. 4 illustrates an exemplary screenshot of the PC editor 340 according to an exemplary embodiment. As shown, the screenshot 400 includes a plurality of tabs in a row on the top portion of the page that help navigate the user during the setup of the customized “project” for the integrated control system 100. According to the exemplary embodiment, the tabs include “setup controller” tab 410, “system configuration” tab 411, “assign zone” tab 412, “zone construction” tab 413, “controlling flow” tab 414, “flow test” tab 415, “assign variables” tab 416, “bi-directional drivers” tab 417, “execute intelli-builder” tab 418, “customize system” tab 419, “emulator” tab 420, and “upload system project tab” 421. It should be understood that the PC editor 340 displays each of these tabs and is configured to provide different design functionalities for the system designer when so selected. The different functionality will be described below, but are generally described as the steps for designing the software application and GUIs for managing the integrated control system 100.

As discussed above, one or more controllers can be registered to the integrated control system 100, which can be done according to the setup controller tab 410. In particular, the setup controller tab 410 enables the user/installer to identify wireless computing devices to operate as the user controller for the control system 100. The steps to set up the user controllers include naming the device(s), specifying the device ID and the IP addresses of each device, and identifying a master user device (if desired) if there are multiple user devices for the integrated control system. Furthermore, the user can add a master controller (e.g., master controller 110), name the master controller, and identify and enter the IP address of the master controller to be used for the integrated control system 100.

Next, the “system configuration” tab 411 of the PC editor 340 enables a user to select all of the electronic devices to be specified in the system during configuration of the integrated control system 100. The exemplary screen shot shown in FIG. 4 illustrates the PC editor 340 when the user has selected the “system configuration” tab 411. The “system configuration” tab 411 enables the user to select all non-controlling electronic devices that will be under the control of the integrated control system 100 and the selection process involves tailoring devices based on control platform, brand, type, and device. As shown in FIG. 4, the “system configuration” tab 411 of the PC editor 340 has a device library 430 and a control library 440.

Devices are selected before they are inserted into a device library 430 for the App. Once the user inputs a name into a “Brand Name” box (e.g., “Main TV”), the user can select the brand name, the device type, and the model number. Individual commands may also be selected for each device. The device is input by category to assign the proper control pathways in subsequent steps of programming.

Once the model number is selected, it is inserted into the device library 430. To insert the model number into the device library 430, the user can select the model number, the category the device is associated with (exemplified as DVD player), and then select add device. The library is organized by device type, with certain devices being controlled by certain platforms (i.e., RS-232, TCPIP, and the like). Thus, in one embodiment, if the device being specified does not appear in the device library, the user can try another control platform, such as RS-232 or TCPIP, to find the electronic device.

Programming the control software begins with inserting devices by control platform. Assuming IR is selected, the user can select “reset brand” and “reset type” to refresh the brand display window. The user can then select the brand, category, and hardware. After selecting the brand, the user can select the category the device is associated with (e.g., set-top box) and click add device. Devices can also be categorized by type, such as audio system, game system, security, and the like. In the exemplary embodiment, these steps are performed for each non-controlling device to be under control in the integrated control system 100.

Once all of the non-controlling electronic devices 130 are inserted into the device library 430 under the “systems configuration” tab 411, the user can use the “assign zone” tab 412 and “zone construction” tab 413 to define each zone (e.g., a room, such as a theatre room, kitchen, etc.) and determine which electronic devices are physically located in each zone. In particular, the “assign zone” tab 412 of the PC editor 340 provides a zone library with a plurality of zone that can be selected by the user. Once the user selects the zone template, the user can drag the specific zone icon (e.g., icon for the “theatre room” or the like) into the system designer window in the PC editor 340. The zones are selected and in the properties window, the types of control affiliated with those zones are specified. In other words, assigning zones involves assigning the zone control type to the zone in order to add respective devices to the zone (e.g., lighting, climate, and the like). Using the “assign zone” tab 412, the user can expand the selected zone tab in the system designer window 430, select the respective zone, and select the type of control types associated with that zone, which can include, for example, video, audio, light, climate, shades, screen, lift, etc. It should be understood that the assign zone steps are performed for each zone in the premise that is to be part of the integrated control system 100.

The “zone construction” tab 413 enables the user to attach the audio and video devices to the mapped zones, i.e., the zones mapped by the assign zones tab 412. In one embodiment, when devices are attached, additional input lines are generated. For example, when a TV is added to a video leg of one of the zones, an additional input line is inserted. Local devices can be attached to this leg.

Using the zone construction tab 413, a user can select the display named with the corresponding zone and attach displays to the respective video lines of that particular zone. The display will provide at least an input line corresponding to the input of the display that the matrix switcher can be attached to in an optional embodiment. After inserting all the display devices into the particular zone, the next step (optional) will be to insert the switcher into the zones to enable a matrix configuration. An output of the matrix switcher goes to the input of the TV and all inputs show up due to the matrix configuration.

Once the sources are attached and the setting is adjusted such that each display shows only the sources specified by the user, the user can then input auxiliary devices into the matrix configuration. For example, to specify lighting and climate into the matrix audio/video system, the user can click on the auxillary tab, select the device, and drag it into each light and climate icon, respectively. When Auxilary devices are added to the system designer, they do not disappear as do displays and sources in the exemplary embodiment. Instead, auxillary devices, such as lights, cameras, temperature, control, and appliances, are added to the specified control route so specified in the assign zones section of programming.

In the exemplary embodiment, the “controlling flow” tab 414 provided in the PC editor 340 enables a user to control data communication routes from the master controller 100 to the non-controlling devices controlled by the integrated control system 100. More particularly, in the previous steps of the project design, the system infrastructure was designed from the perspective of audio/video infrastructure. As described above, the type of equipment was specified, the types of zones were specified, the control lines within the zones were specified, and the hardware was specified to the zone corresponding to the location of the hardware. Using the “controlling flow” tab 414, the PC editor 340 enables the user to define the actual command routes, i.e., the system is built from the perspective of the command routes as opposed to the hardware locations.

Once the user selects the “controlling flow” tab 414 or icon, the user can select the master controller icon (i.e., the icon for the master controller 110) from the device library and the drag the icon to the system designer window on the left side of the PC editor 340. Once the master controller is specified in the system, the user controller is to be specified. The master controller 110 provides command routes wherein the electronic devices 130 controlled by various control platforms are inserted into the ordained command routes. Therefore, IR devices are placed in IR command routes, RS-232 devices are placed in RS command routes, TCP/IP devices are placed in TCPIP command routes, serial IR devices are placed in IR command routes, relay devices are placed in relay command routes, and so forth. The master controller 110 is input into the system followed by the user controllers (e.g., controllers 120A and 120B discussed above).

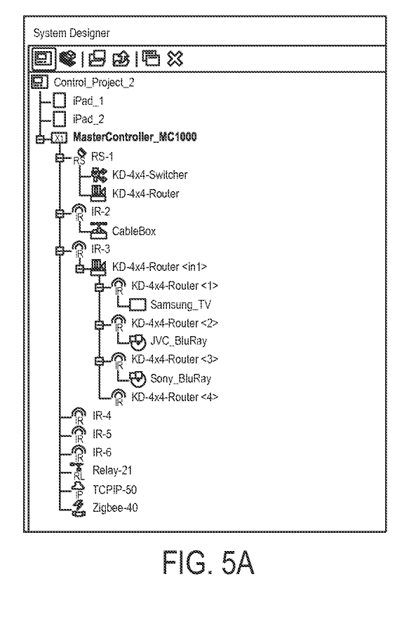

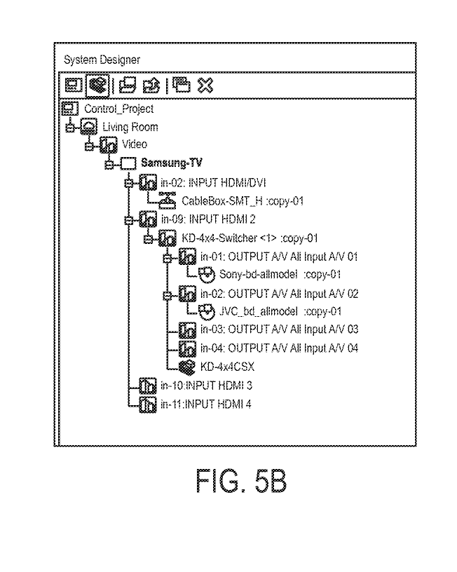

FIG. 5A illustrates a command route tree provided in the system designer widow of the PC editor 340 according to an exemplary embodiment. In particular, to specify the type of remote control in the system, the user can select the user controller (e.g., “iPad_{—}1” and “iPad_{—}2”), drag it to the master controller icon, and maximize the master controller command route tree as shown in FIG. 5A. Once the controller units are specified into the system designer window, the devices are then inserted. As shown, the first device inserted is the “KD-4×4-Switcher”, i.e., the matrix switcher, that is specified into the main RS-232 port (i.e., “RS-1”). To insert the matrix switcher into the system designer, the user can select the matrix switcher from the device library and drag the icon to the RS-232 port shown in the command route tree of FIG. 5A. Each device in the device library has a command platform designation based on prior specification during system configuration (discussed above). Accordingly, the user can go through each device and correspond the system designer command platforms with the command platforms in the A/V system.

In the exemplary A/V system, the matrix switcher and the router (providing control signals) are coupled to the RS-1 port of the master controller 100, which is the main RS-232 port as noted above. Furthermore, there are two devices (i.e., the “CableBox” and input 1 of the “KD-4×4-Router”) that are connected to two of the IR ports of the master controller. In addition, the “KD-4×4-Router” has four IR output ports with three separate devices respectively connected to three of the IR ports. In the exemplary embodiment, these non-controlling devices are “Samsung_TV”, “JVC_BluRay”, “Sony_BluyRay”. As will be described in detail below, the command route tree is customizable by the user/system designer. In the example shown in FIG. 5A, when the user sends a “Play” command to the “Sony_BluyRay”, the command route tree will send a RS-232 command to the “KD-4×4-Router” through the master controller 100 (i.e., “MasterController_MC1000”) port “RS-1” to switch the IR routing of the master controller 100 from input 1 to output 3. As a result, the “Play” command will be sent to the “Sony_BluyRay” through the port “IR-3” of the master controller 100.

In the exemplary embodiment, the user can deine and change command platforms routes in the tree shown in FIG. 5A, for example. In one embodiment, the user can change the command platform routes by right clicking on the command platform and changing it to the desired command platform route. For example, a user can right click on the default IR pathway and change it to the RS-232 pathway. It should be understood that the user's control in the command route tree will define the actual flow of command signals from the controllers 120A and/or 120B to the desired controlled devices 130 during actual implementation and operation of the integrated control system 100.

In the exemplary embodiment, once all the sources have the same command platforms as the master controller 110, the user can drag each device to its corresponding command route. In one refinement, if the platforms do not match, the PC editor 340 will prevent the specific device from being specified in the system. More particularly, as described above, devices were inserted into the system designer based on the command platform (e.g., IR, RS-232, etc.) that controls the device and was specified during the system configuration stage of programming of the App. The command platforms are now specified to their corresponding devices. If the devices are inserted into the respective command pathways, and the software has accepted the command platforms, the hardware has been properly specified.

In an additional embodiment, the PC editor 340 provides the user with the ability to control command flow based on the defined zones in the system.

FIG. 5B illustrates a command route tree for control zones that is provided in the system designer widow of the PC editor 340 according to an exemplary embodiment. In this embodiment, the command route tree illustrates the activities that each zone has and how the audio and video signals flow in that zone. As shown in FIG. 5B, the zone is the “Living Room” of the premise and the signals are the “Video” signals. The specific video device is “Samsung-TV” with four connected inputs “in-02”, “in-09”, “in-10”, and “in-11”. As shown, input in-02, which is an HDMI/DVI input, has a CableBox connected thereto and input in-09 is connected to output <1> of the KD-4×4-Switcher. Furthermore, the KD-4×4-Switcher (i.e., the matrix switcher) has two inputs, which are the “Sony-bd-allmodel” and the “JVC_bd_allmodel”. Accordingly, in this configuration, when a user wishes to “play” the “JVC_bd_allmodel” for video activity in the living room, a first command is sent to switch the output 1 to input 2 of the “KD-4×4-Switcher” video switcher and a second command is sent to switch the “Samsung-TV” to input 9, which is input HDMI 2 of the TV. Similar to the command route tree shown in FIG. 5A, the tree for audio/video signal control flow for zones as shown in FIG. 5B can be modified and customized by the user during system design.

Referring back to FIG. 4, the PC editor 340 further includes a “flow test” tab 415. This tab enables the user/installer to test the flow of control signals once the command route trees are designed, as described above, and all of the electronic devices are physically installed and coupled to the master controller 100. The flow test can be performed on an individual device base to test command packets and controller flow. In particular, the user/installer can select a device with its corresponding command packet and press play to ensure that the indivual device is properly connected to the master controller 100. The system is configured to route test signals to ensure all devices are physically connected in the correct setup according to the flow trees defined by the user.

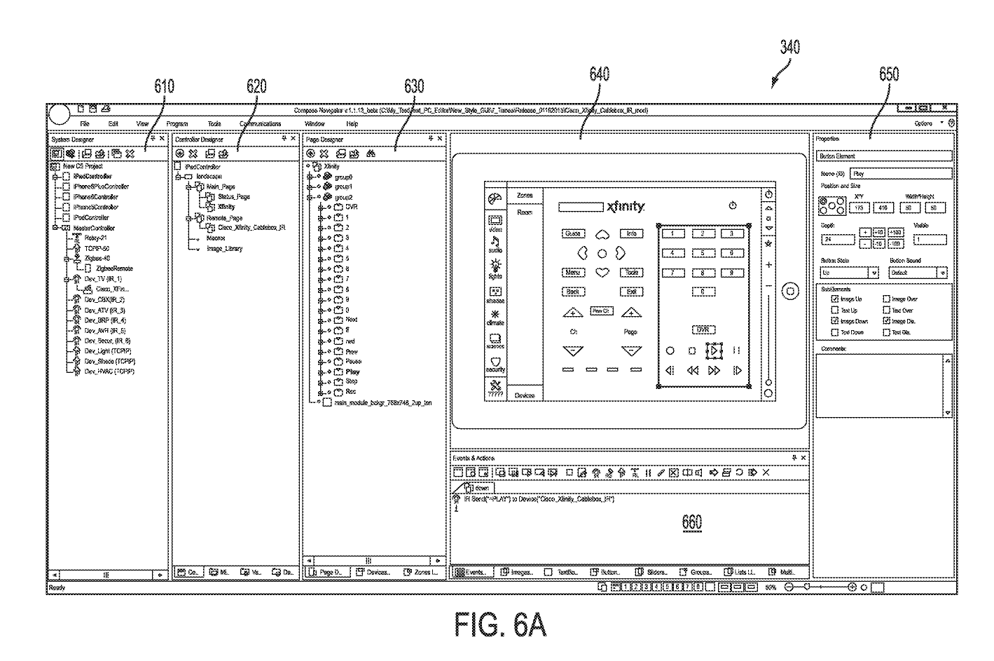

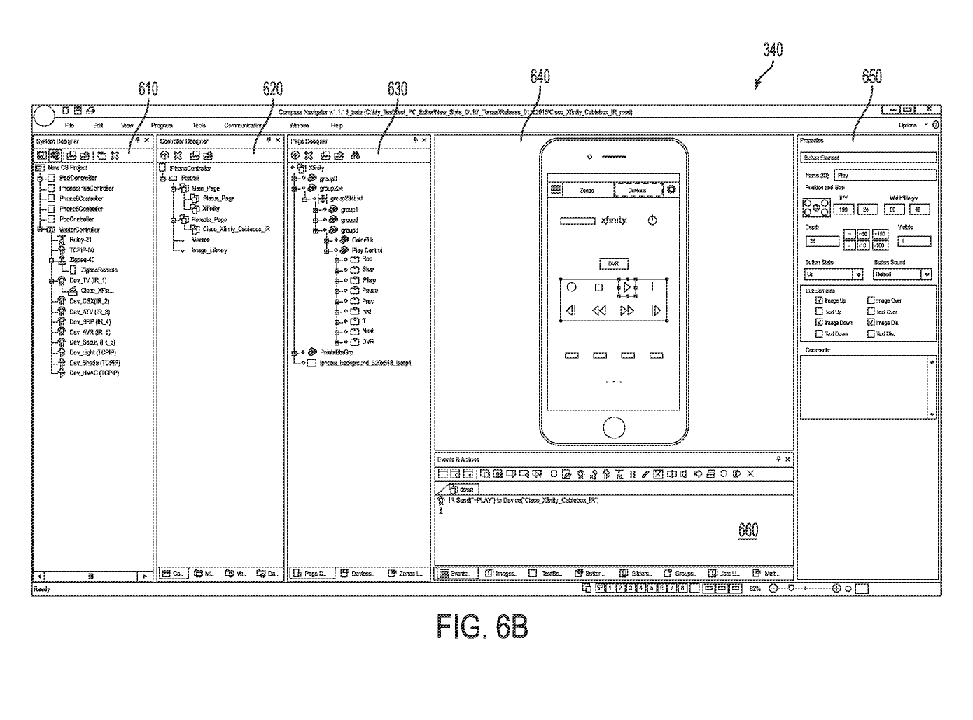

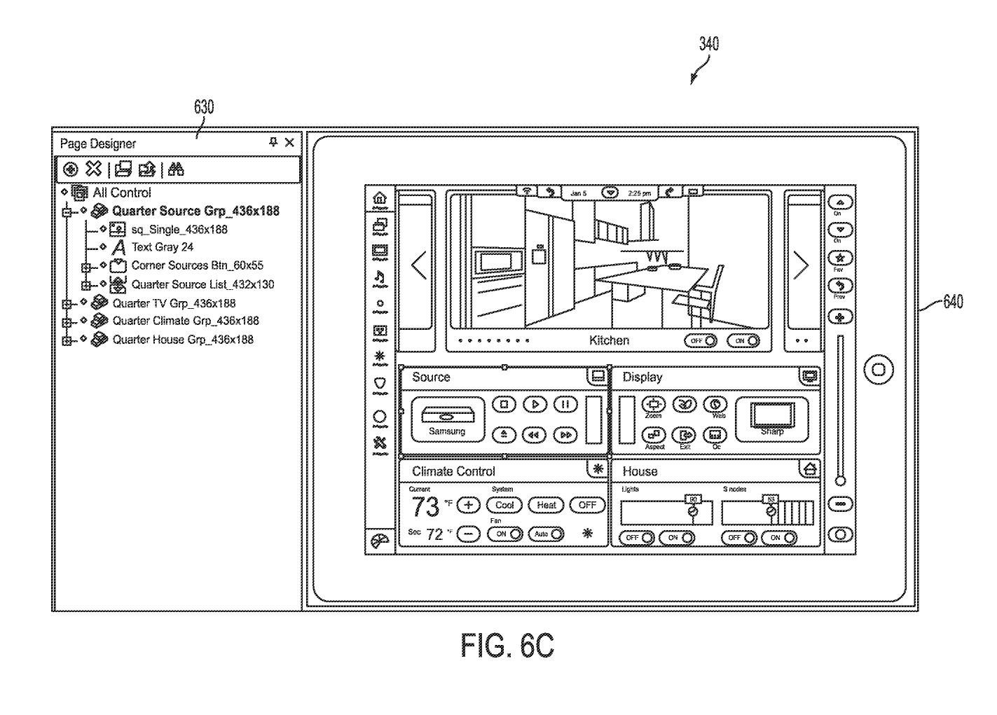

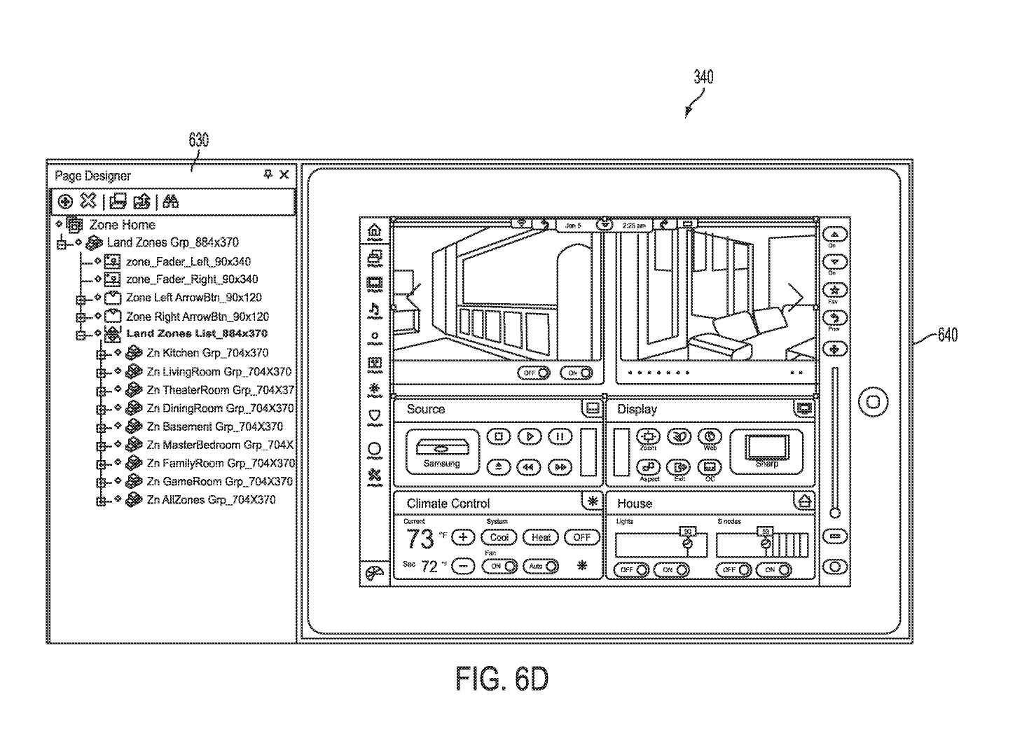

FIGS. 6A and 6B illustrates examples of the visual module editor according to an exemplary embodiment of the present invention. The visual module editor enables the user/installer to configure the graphical user interface (“GUI”) for each user controller (e.g. controllers 120A and 120B) of the integrated control system 100. The visual module editor provides a unique experience for the user/installer to customize the layout and presentation for each controller.

A visual module editor (or device module for editing) can be can be launched by selecting device module file instead of project file after selecting “Open” in “File” menu. As shown in FIGS. 6A and 6B, the visual module editor of the PC editor 340 includes a “System Designer” window 610, a “Controller Designer” window 620, a “Page Designer” window 630, a visual presentation of the controller template 640, and a “Properties” window 650. The “Controller Designer” window 620 maintains the pages of the GUI for the finalized App while the “Page Designer” window 630 maintains the graphics for each selected page with items displayed on the GUI being organized in a file structure in this window.

Once the user selects launches the device module for editing, the user first can select the specified controller device in the System Designer window 610. FIG. 6A illustrates an exemplary embodiment for an “iPadController” and FIG. 6B illustrates and exemplary embodiment for an “iPhone6Controller”. Next, the user can select the “Main_Page” in the “Controller Designer” window 620, which in the exemplary embodiment is for an Xfinity® cable box. It is contemplated that the database of the PC editor 340 includes a plurality of graphic templates that correspond to a visual presentation of each possible electronic device that can be configured to be under the integrated control system 100. Accordingly, when the user selects “Xfinity” in the “Controller Designer” window 620, a visual representation (i.e., an emulation) of the Xfinity cable box controller will be displayed in window 640.

Each graphic of the emulated controller can be linked to commands that are referred to as “Events and Actions” for the PC editor 340. Events and Actions are processes that are executed with the graphic is engaged, such as sending commands to respective hardware. FIGS. 6A and 6B illustrate an “Events and Actions” window 660 of the PC editor. The commands operate to link the graphics in the “Page Designer” window 630 and operate to send commands to the respective audio/video devices (e.g., the Xfinity cable box). As shown in FIGS. 6A and 6B, the exemplary command is the “Play” command that is linked to the play button (i.e., the highlighted right arrow) of the emulated controller with the command listed in the “Properties” window 650 and the “Events and Actions” window 660. The “Events and Actions” window 660 illustrates a “down” command that indicates that the action will be performed when the icon is pressed down when a user is using the finished App in operation of the integrated control system 100.

Once the Event & Action is created (e.g., “Play”), the type of event can be specified. In one embodiment, creating an Event & Action only need take place once for a given graphic. Subsequent “Events & Actions” are created by stringing further commands on one, newly created, “Event & Action”. In other words, the user only has to press the “+” buttons once and then insert new “Events and Actions” as the project bears.

Although FIGS. 6A and 6B illustrate an example in which the user has selected the emulated controller for the Xfinity cable box, it is contemplated that the user can also create a GUI from scratch or modify an existing GUI in the database. In these instances, the user can insert buttons into the GUI. To insert a button, the user can go to a “Button” library (the tab is shown at the bottom of the screenshots of FIGS. 6A and 6B), select the desired button, and drag the selected button into window 640 with the new GUI. Once the selected button is positioned in the GUI, the user can set the properties depth to at least “2” so the button is moved to a visible position above the background in relation to the background which is at depth “1”. In the exemplary embodiment, the button is an animated graphic with three distinct states, represented by the button being pressed up, down, or over. Depending on how the button is ultimately pressed by the user in the system, it will display these different looks. Next, the user can again select the Events & Actions tab revealing the “Events and Actions” window 660 window, discussed above.

FIGS. 6C and 6D illustrate additional screenshots of the PC editor 340 for generating customized GUIs for the App(s). As shown in FIG. 6C, the user/installer can easily group elements for easy programming and organizing. In particular, in the “Page Designer” window 630 of the PC editor 340, the user customize a quartet of group elements as “Source”, “Display”, “Climate Control” and “House” for the “Kitchen” zone. In the “Page Designer” window 630, the user can adjust the position and other characteristics of the group elements. Moreover, as shown in FIG. 6D, the PC editor further enables the user to modify and customize the vertical and horizontal sliding of groups inside an assigned area for increased control. For example, the user can set the order of zones shown and cycled through in a horizontal sliding functionality.

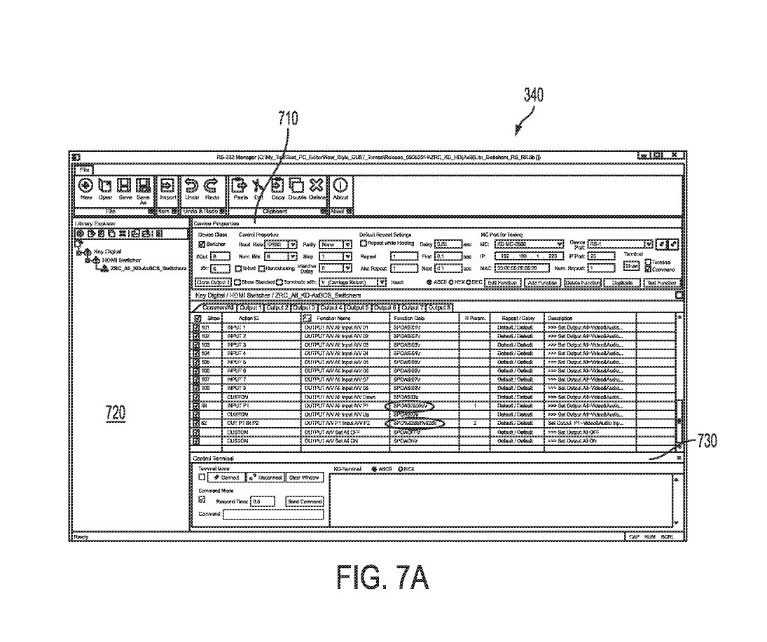

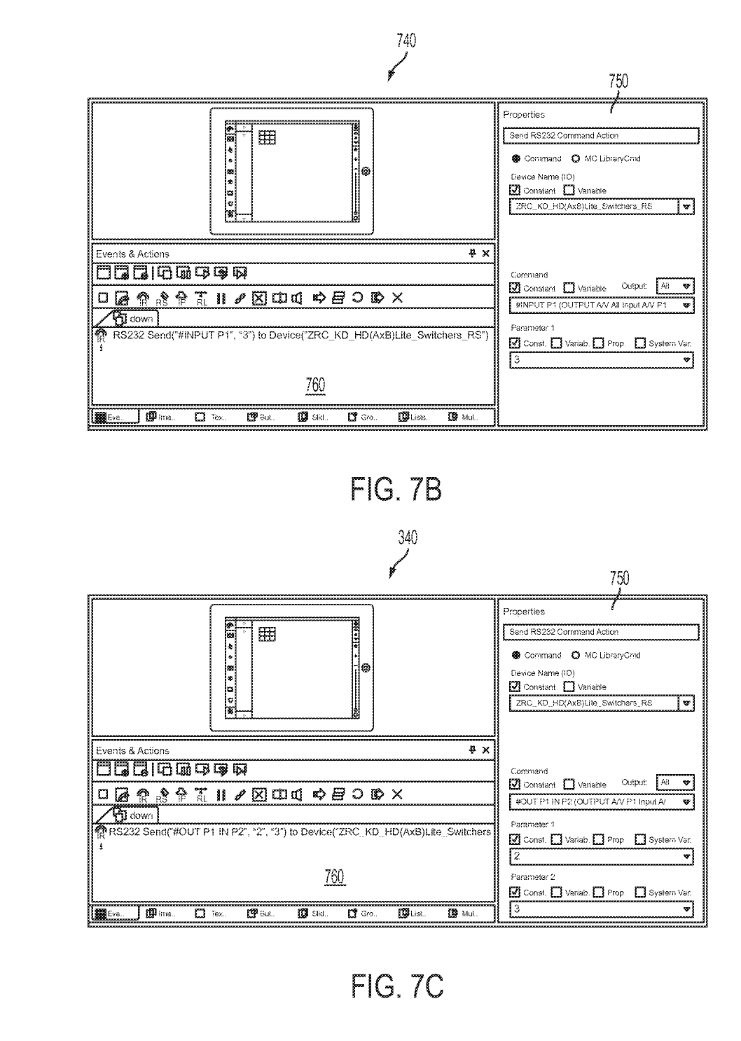

In the exemplary embodiment, the PC editor 340 further provides variable parameters for the control libraries (e.g., RS-232 and TCPIP control). FIGS. 7A-7C illustrate exemplary screenshots of the PC editor enabling the user/installer to define the variable parameters for the HDMI switcher according to an exemplary embodiment.

In particular, FIG. 7A illustrates a database manager “Device Properties” window 710, a “Library Explorer” window 720 and a “Control Terminal” window 730. FIGS. 7B and 7C illustrate portion of the screen shot including the “Events and Actions” window 760 and “Properties” window 750, which are similar to the windows discussed above with respect to FIGS. 6A and 6B.

In particular, the database manager shown in FIG. 7A allows commands sets to be edited, refined or even developed from scratch for use in system configurations. There are three database managers provided in the exemplary system: an IR manager, an RS-232 manager and a TCP/IP manager. Each of the database manager are configured to offer functionality that provide sophisticated levels of customization. Moreover, each database manager contains existing libraries that are editable by the user, such that components can be added, deleted or the actual code sets can be altered as needed to provide better operation. Codesets can even be imported from an existing project and edited. In this way, a set of commands that need to be tweaked for optimal control of a specific component, can be opened from the project file and edited. In addition, each database manager allows the user to create of a user-defined library. Each user/programmer can develop their own subset of most often used devices, which then grants easier access to these components during the programming process.

FIG. 7A specifically illustrates a screenshot of the PC editor for the RS-232 database manager. This database manages command protocols by allowing codes to be added, edited, deleted, and whole codesets generated. Additionally, the user can test any code through the database using the master controller 110, for example. In the exemplary embodiment, commands can be written using ASCII, Decimal, or Hex, and suffixes can be automatically added to each command in a codeset such as carriage return and form feed, as would be understood to one skilled in the art. As further shown, the matrix switcher control commands can be organized by outputs of the matrix switcher. In particular, as shown in the “Device Properties” window 710 of the screenshot, the user can select each of the eight outputs for the matrix switch and define the codes accordingly.

Although not shown, the IR database manager is configured to enable programmers to oversee the IR codesets in the database, which includes altering the actual codes and/or codesets themselves, adding devices, adding codes or codesets to the database, importing codes and/or codesets, and creating new device codesets by learning the IR codes into the database (as discussed above) or using pronto hex codes. The IR database manager also allows the set-up of the default settings for a particular codeset. Additionally, the IR database manager provides the user with a method to test the codes through the master controller 110 to ensure that a particular code or full codeset operates the specific device properly. Moreover, the TCP/IP database manager allows the programmer to manage the one-way IP commands in the database in the same way as the RS-232 command sets in the RS-232 database manager.

In the example shown in FIGS. 7B and 7C, the user/installer can select the “RS” action tab to add a “Send RS232 Command Action”, for example. Once the action is inserted in the “Events and Actions” window 760, the “Properties” window 750 will change according to the display of FIGS. 7B and 7C. In the exemplary embodiment, the PC editor 340 provides the user/installer with the ability to define whether the command (i.e., “Send RS232 Command Action”) is a constant or variable parameter. In this instance, the user has selected the command to be constant and has been provided with a drop down or scroll down menu the allows the user to select the device where the RS-232 command is to be directed (i.e., the “ZRC_KD_HD(AxB)Lite_Switchers_RS”). It should be appreciated that the available devices in the drop down menu are the devices specified during the system configuration step discussed above. Once the device has been designated to receive the RS-232 command, the user/installer can define the “Command” portion of the “Properties” window 750 to select the desired command to control the system. In this example, the designated command is constant, which is a single command that will be sent to the specified constant device. Again, the possible commands can be retrieved from a drop down menu, which is shown as “#INPUT P1 (OUTPUT A/V All Input A/V P1”. Furthermore, the “Parameter 1” can be one of four different types of parameters and the user can select the specific parameter from another drop down menu. In FIG. 7A, the selected “Parameter 1” is “3” and in FIG. 7B the “Parameter 1” is “2” and the “Parameter 2” is “3”.

As described above with respect to in FIGS. 6A-D and 7A-C, the user can fully define the project by customizing every feature of every GUI defined by for the App. This is done when the user selects the “customize system” tab 419. In contrast, the PC editor 340 also provides a software that provide a certain level of automation for the process. In particular, the software is referred to as an intelligent building software (i.e., “Intellibuilder”) and can be executed when the user selects the “execute intelli-builder” tab 418 in the PC editor 340. When executed, this software will preload variables, macros, and bi-directional drivers as well as configure the template GUI system. The software is further configured to compile the GUIs alongside control route platforms for seemless integration and programming of the A/V system.

In either case, once the system project (i.e., the App) is finalized by the user/installer, it can be uploaded to a server and/or data cloud using the “upload system project tab” 421, as shown in FIG. 4.

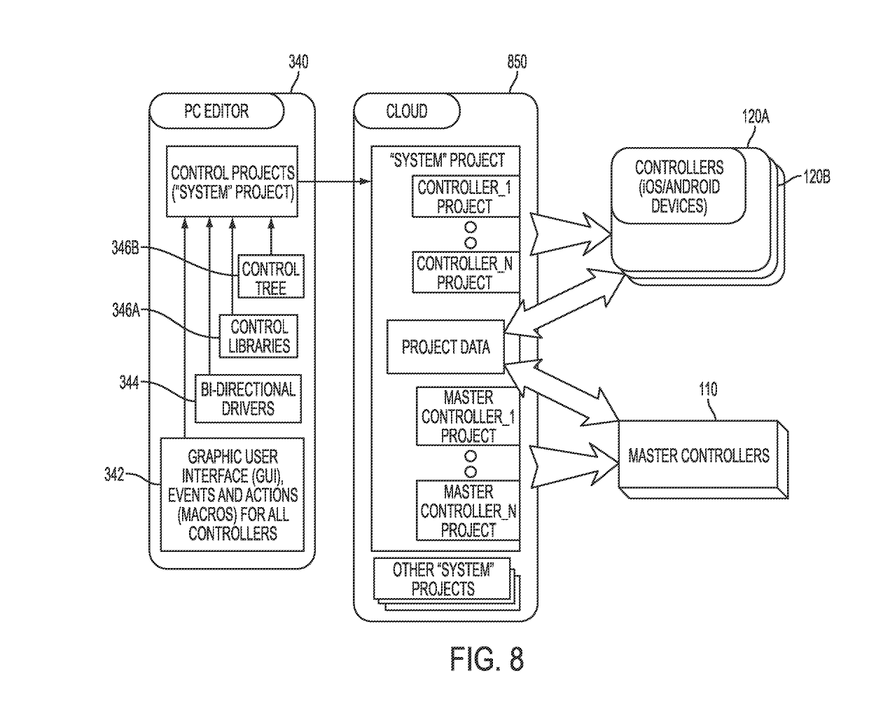

FIG. 8 illustrates a flowchart for uploading the control projects to the server and/or cloud according to an exemplary embodiment. As described above, the PC editor 340 includes the GUIs, the bi-directional drivers, the control libraries, and control tree, all discussed above. These components of the PC editor 340 enable the user/installer to fully design and customize the App according to user preferences. In particular, all electronic device physical connections, command paths, the GUI displays, and the like, are specified by the user. Once these system projects are finalized, they can be upload to cloud 850 as “Controller_{—}1 Project” . . . to “Controller_N Project”. Each project can then be downloaded by a specific user controller (e.g., controller 120A and/or 120B of FIG. 1) that will be utilized in the integrated control system of the premise. For example, referring to FIG. 1, controller 120A can download “Controller_{—}1 Project”, controller 120A can download “Controller_{—}2 Project” and the like. The Apps can then be executed by processors of the user controllers that, upon execution, will cause the controller displays to present the graphical user interfaces created by the user/installer (as discussed above). The user/installer can then control the non-controlling devices 130 using the graphical user interfaces and the control will be based on the commands defined by the user.

In the exemplary embodiment, each controller project can only be downloaded on a single controller and each individual controller must have its own license for using the project. Thus, according to the exemplary embodiment, each controller project will be assigned a unique identification number that will be linked to the IP address of the specific device identified during system configuration as discussed above. Thus, if the user were to lose a controller or the like, the user could request the project to be downloaded to a new controller, but a new identification number must be generated and linked to that new controller. As a result, a user could not download a copy of the same project to multiple devices according to one embodiment.

Referring back to FIG. 3, the App downloaded to each controller includes a project interpreter and a master controller emulator. As shown by the arrows in the block diagram of FIG. 3, the project interpreter can execute the controller application 150, which is used to send command signals to the master controller(s) 110 as described above. In addition, in one embodiment every App has an embedded master controller emulator that can control devices independently of the hardware master controller 110. In this embodiment, the master controller emulators perform the same command routing as the master controller 110 by routing the command signals to the electronic devices 130, but does so by sending signals over the wireless network of the premise. Therefore, in this embodiment, each electronic device controlled by the integrated control system 100 is includes a wireless data connection that communicatively couples the device to the WiFi network of the premise or the like. Therefore, all of the command routes defined by the user (as discussed above) will proceed through the master controller emulator(s) instead of the hardware master controller 110 as would be understood to one skilled in the art.

Furthermore, it is contemplated that if there are multiple controllers used in the integrated control system 100, each of the controllers is synchronized according to the exemplary embodiment. In other words, the system is designed to maintain the controllers 120A and 120B and the master controller(s) 110 as a common system, such that all the controllers have the same status, time, variables, devices, etc. Thus, when one controller (e.g., controller 120A) enters a command, such as “play” the Blu-Ray player, this command has a timestamp and the “play” status is synchronized for all other controllers integrated into the system. Thus, if the user subsequently starts using controller 120B, for example, the controller 120B will indicate that Blu-Ray player is currently being played. The synchronization can be achieved by directly transmitting that status updates from one controller to the second controller and so forth, or by transmitting the status updates to the cloud 850, which are then retransmitted to each other controller in the network.

It should be appreciated to one skilled in the art that when there are multiple controllers (e.g., controllers 120A and 120B) that can potentially provide instructions to the same electronic device, the integrated control system needs to provide a sequence control to ensure that all commands that are part of a sequence/macro are executed before another sent command is executed.

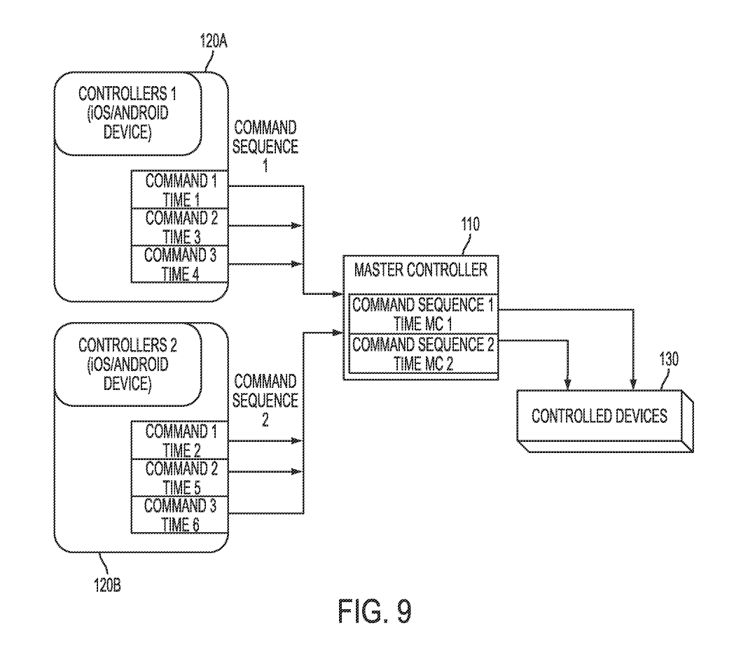

FIG. 9 illustrates a block diagram with flow signals for sequence control according to an exemplary embodiment. Similar to the diagram shown in FIG. 1, FIG. 9 illustrates a block diagram including two user controllers 120A and 120B, a master controller 110, and electronic controlling devices 130. For proper sequence control, when an event or macro is created, commands must be performed back-to-back in the pre-programmed sequence to prevent additional incoming commands from interrupting/overriding an event or macro sequence. In the example of FIG. 9, controller 120A provides a first command sequence 1 and controller 120B provides a second command sequence 2. In the example, the two command sequences may be commands for two different television stations, such as station “110” and “130”, for example. Moreover, command 1 would be the digit “1”, command 2 would be the digit “1”, and command 3 would be the digit “0”, for controller 1. Similarly, command 1 would be the digit “1”, command 2 would be the digit “3”, and command 3 would be the digit “0”, for controller 2. As shown, because command 1 is entered at time 1, the integrated control system 100 generates a timestamp for command 1 of controller 1, which gets priority. Therefore, the entirety of command sequence 1 (i.e., “110”) is received by the master controller 110 and transmitted to the appropriate device of devices 130. After command sequence 1 is transmitted, the master controller 110 will then transmit command sequence 2 to the appropriate electronic device. Accordingly, it should be understood that the sequence control is being maintained in a first in, first out protocol, such that even if command 1 of controller 2 is entered in time before command 2 of controller 1, command sequence 1 will still be executed first because command 1 was entered first in time. The sequence control can be performed by the processor of the controllers 120A and/or 120B or by the MCU 216 of the master controller 110 in the exemplary embodiment.

Finally, as described above, the remote user controllers 120A and 120B are configured to wirelessly communicate with the master controller 110 and/or the electronic devices 130 using a wireless network in the premise, such as a WiFi network or the like. Alternatively, the remote user controllers 120A and 120B can be communicatively coupled to the master controller using a wired connection.

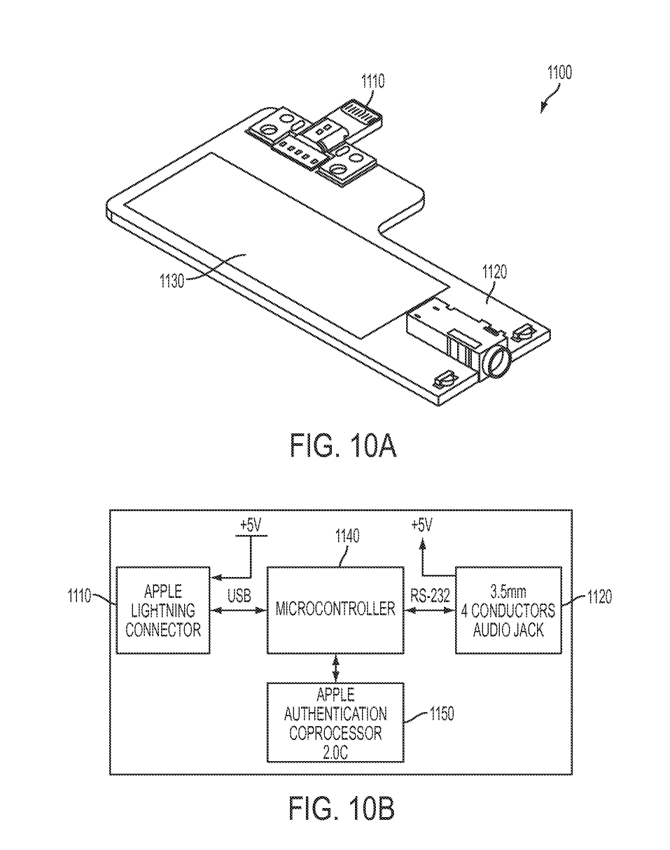

FIG. 10A illustrates a coupling mechanism for connecting a user controller (i.e., an Apple iPad®) to the master controller 110 according to an exemplary embodiment. As shown, coupling mechanism 1100 is a converter that includes an Apple Lightning® connector port 1110 that receives the commands from the user controllers 120A and 120B and transmits them to the master controller 110 by a 3.5 mm 4 conductors audio jack 1120 (as discussed above with respect to FIG. 2A). The coupling mechanism further includes a circuit board 11130 for housing the port 1110 and the audio jack 1120.

FIG. 10B illustrates a block diagram of the coupling mechanism shown in FIG. 10A. In particular, the coupling mechanism further includes a microcontroller 1140 and an Apple authentication processor 1150 that work in conjunction to convert the command signals from the controller 120A and 120B to be transmitted on the standard RS232 interface to the master controller 110. In the exemplary embodiment, the port 1110 and the audio jack 1120 are provided with +5V power from the master controller 110 as would be understood to one skilled in the art. It should be appreciated that by using the wired coupling mechanism as opposed to a WiFi network to transmit command signals from the controller 120A and 120B to the master controller 110, the integrated control system 100 can achieve a very secure and reliable mechanism for command signal transmission.

Accordingly, it should be appreciated that the above description and drawings are only to be considered illustrative of specific embodiments, which achieve the features and advantages described herein. Modifications and substitutions to specific process conditions can be made. Accordingly, the embodiments in this patent document are not considered as being limited by the foregoing description and drawings.

What is claimed is:

1. A method for controlling a plurality of electronic devices in a control system of a premise, the method comprising:
programming an electronic configuration relating to a physical design of the control system by:
identifying device data in a database for each of the plurality of electronic devices by entering identification data relating to the plurality of electronic devices,
identifying at least one computing device to operate as a controller for the control system,
identifying a hardware controller that is configured to communicate with the at least one computing device and comprises a plurality of output ports that are configured to physically connect to the plurality of electronic devices;
generating a plurality of command routes for transmitting operational commands from the at least one computing device to the plurality of electronic devices via the hardware controller; and
testing a control flow of the operational commands to confirm that the hardware controller and the plurality of electronic devices are physically connected according to the generated plurality of command routes.

2. The method according to claim 1, further comprising generating a software application that, when executed by a processor of the at least one computing device, causes the at least one computing device to display a plurality of graphical user interfaces.

3. The method according to claim 2, wherein the step of generating the software application comprises designating a plurality of zones in the premise and associating a portion of the plurality of electronic devices to each zone of the plurality of zones in the premise.

4. The method according to claim 2, further comprising receiving at least one of the operational commands via one of the graphical user interfaces.

5. The method according to claim 3, further comprising transmitting the at least one operational command from the at least one computing device to one of the plurality of electronic devices according to a respective command route of the at least one operational command.

6. The method according to claim 1, wherein the step of generating the plurality of command routes comprises defining a route tree defining the command routes for the operational commands.
